(19) United States
(12) Patent Application Publication
(10) Pub. No.: US 2019/0102847 A1
(43) Pub. Date: Apr. 4, 2019

(54) SYSTEM AND METHOD FOR CONNECTING A POTENTIAL BUYER AND AN AVAILABLE REALTOR IN REAL TIME

(71) Applicant: KevoApp1, LLC, Oklahoma City, OK (US)

(72) Inventor: Steven Hamilton Burris, Yukon, OK (US)

(21) Appl. No.: 16/148,787

(22) Filed: Oct. 1, 2018

Related U.S. Application Data
(60) Provisional application No. 62/574,053, filed on Oct. 18, 2017.
(60) Provisional application No. 62/566,085, filed on Sep. 29, 2017.

(51) Int. Cl. G06Q 50/16; G06Q 30/06; H04W 4/02

(52) U.S. Cl. CPC G06Q 50/16; H04W 4/023; G06Q 30/0635

(57) ABSTRACT

Systems and methods for establishing communication between at least one host system, at least one buyer device, and at least one realtor device are disclosed. The system determining a current location of the at least one buyer device using a device locator and sending at least one selectable indicator associated with a location of available realtors located within a determined distance of the current location of the buyer device. Upon selection of a selectable indicator, the system facilitates the showing of a property associated with the current location of the user device by connecting a realtor associated with the selectable indicator and buyer associated with the buyer device. Once the showing has been accepted, the system provides real-time updates of the realtors location as they travel to the showing.

### CROSS REFERENCE TO RELATED APPLICATION/INCORPORATION BY REFERENCE

The present patent application claims priority to the provisional patent applications identified by U.S. Ser. No. 62/566,085, filed on Sep. 29, 2017, and U.S. Ser. No. 62/574,053, filed on Oct. 18, 2017, the entire contents of each of which are hereby expressly incorporated by reference herein.

### BACKGROUND

Those seeking to purchase real estate (a buyer or buyers) and realtors have traditionally connected using static services such as telephone books, websites, or other directories to find one another.

Such static services, however, do not allow the realtor and or the buyer to connect in real time on a schedule that is convenient for both the buyer and the realtor. For instance, a person who is in the market to purchase a property may see a property for sale as they are out driving through a neighborhood. Traditionally, the buyer would then be left with the option to call the realtor listed on the for sale sign at the property, for instance, or call realtors listed in one of the static services hoping to find one that is available to show them the property. This method has several disadvantages. First, the property may be placed under contract before the potential buyers can see the property because they could not find an available realtor. Second, an available realtor may already be in the area but have no way of knowing there is a potential buyer who would like to see a property.

Therefore, a need exists for a system and method of connecting potential buyers and available realtors in real-time. It is to such an improved system and method that the presently disclosed inventive concepts are directed.

### BRIEF DESCRIPTION OF THE SEVERAL VIEWS OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, not every component may be labeled in every drawing.

FIG. 1 is a diagrammatic view of hardware forming an exemplary embodiment of a system for connecting a potential buyer and an available realtor constructed in accordance with the present disclosure.

FIG. 2 is a diagrammatic view of an exemplary user device for use in the system for connecting a potential buyer and an available realtor illustrated in FIG. 1.

FIG. 3 is a diagrammatic view of an exemplary embodiment of a host system for use in the system for connecting a potential buyer and an available realtor illustrated in FIG. 1.

FIG. 4 is a flow diagram illustrating operation of an exemplary method of connecting a potential buyer and an available realtor in accordance with the present disclosure.

FIG. 5 is an illustration of an exemplary login screen in accordance with some embodiments of the present disclosure.

FIG. 6 is an illustration of an exemplary buyer home screen in accordance with some embodiments of the present disclosure.

FIG. 7 is an illustration of an exemplary property information screen in accordance with some embodiments of the present disclosure.

FIG. 8 is an illustration of an exemplary realtor selection screen in accordance with some embodiments of the present disclosure.

FIG. 9 is an illustration of an exemplary realtor information screen in accordance with some embodiments of the present disclosure.

FIG. 10 is an illustration of an exemplary requested showing screen in accordance with some embodiments of the present disclosure.

FIG. 11 is an illustration of an exemplary realtor progress tracking screen in accordance with some embodiments of the present disclosure.

FIG. 12 is an illustration of an exemplary realtor arrived screen in accordance with some embodiments of the present disclosure.

FIG. 13 is an illustration of an exemplary realtor home screen in accordance with some embodiments of the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The systems and methods as described in the present disclosure are capable of other embodiments or of being practiced or carried out in various ways. Also, it is to be understood that the phraseology and terminology employed herein is for purposes of description, and should not be regarded as limiting.

The following detailed description refers to the accompanying drawings. The same reference numbers in different drawings may identify the same or similar elements.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, any reference to “one embodiment,” “an embodiment,” “some embodiments,” “one example,” “for example,” or “an example” means that a particular element, feature, structure or characteristic described in connection with the embodiment is included in at least one embodiment. The appearance of the phrase “in some embodiments” or “one example” in various places in the specification is not necessarily all referring to the same embodiment, for example.

Circuitry, as used herein, may be analog and/or digital components, or one or more suitably programmed processors (e.g., microprocessors) and associated hardware and software, or hardwired logic. Also, “components” may perform one or more functions. The term “component” may include hardware, such as a processor (e.g., microprocessor), a combination of hardware and software, and/or the like. Software may include one or more computer executable instructions that when executed by one or more components cause the component to perform a specified function. It should be understood that the algorithms described herein may be stored on one or more non-transitory memory. Exemplary non-transitory memory may include random access memory, read only memory, flash memory, and/or the like. Such non-transitory memory may be electrically based, optically based, and/or the like.

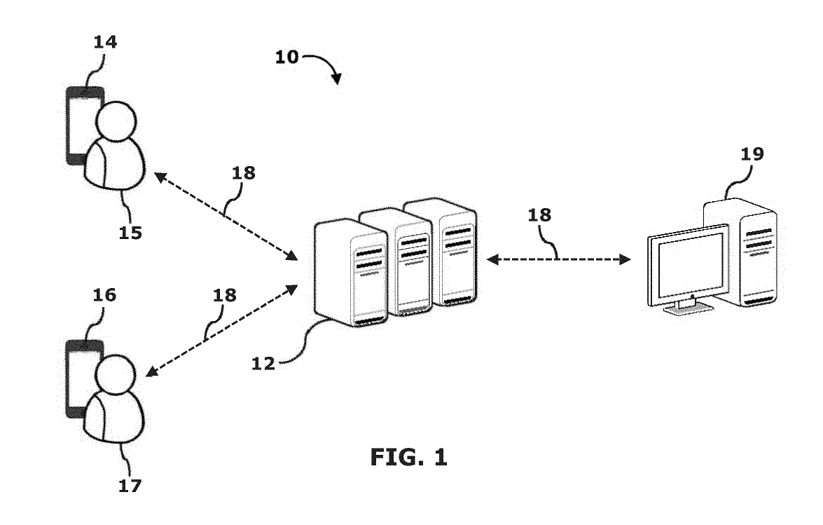

Referring now to the Figures, and in particular to FIG. 1, shown therein is a diagrammatic view of hardware forming an exemplary embodiment of a system 10 for connecting a real estate agent and a potential buyer in real-time constructed in accordance with the present disclosure.

The system 10 is provided with at least one host system 12 (hereinafter “host system 12”), a plurality of buyer devices 14 (hereinafter “buyer device 14”), a plurality of realtor devices 16 (hereinafter “realtor device 16”), and a network 18. In some embodiments, the system 10 may include at least one external system 19 (hereinafter “external system 19”) for use by an administrator to add, delete, or modify user information, provide management reporting, or manage property or seller information. The system 10 may be a system or systems that are able to embody and/or execute the logic of the processes described herein. Logic embodied in the form of software instructions and/or firmware may be executed on any appropriate hardware. For example, logic embodied in the form of software instructions and/or firmware may be executed on a dedicated system or systems, on a personal computer system, on a distributed processing computer system, and/or the like. In some embodiments, logic may be implemented in a stand-alone environment operating on a single computer system and/or logic may be implemented in a networked environment such as a distributed system using multiple computers and/or processors as depicted in FIG. 1, for example.

The host system 12 of the system 10 may include a single processor or multiple processors working together or independently to perform a task. In some embodiments, the host system 12 may be partially or completely network-based or cloud based. The host system 12 may or may not be located in single physical location. Additionally, multiple host systems 12 may or may not necessarily be located in a single physical location.

In some embodiments, the system 10 may be distributed, and include at least one host system 12 communicating with one or more buyer device 14 via the network 18. As used herein, the terms “network-based,” “cloud-based,” and any variations thereof, are intended to include the provision of configurable computational resources on demand via interfacing with a computer and/or computer network, with software and/or data at least partially located on a computer and/or computer network.

In some embodiments, the network 18 may be the Internet and/or other network. For example, if the network 18 is the Internet, a primary user interface of the system 10 may be delivered through a series of web pages or private internal web pages of a company or corporation, which may be written in hypertext markup language. It should be noted that the primary user interface of the system 10 may be another type of interface including, but not limited to, a Windows-based application, a tablet based application, a mobile web interface, and/or the like.

The network 18 may be almost any type of network. For example, in some embodiments, the network 18 may be a version of an Internet network (e.g., exist in a TCP/IP-based network). It is conceivable that in the near future, embodiments within the present disclosure may use more advanced networking technologies.

In some embodiments, the external system 19 may optionally communicate with the host system 12. For example, in one embodiment of the system 10, the external system 19 may supply data transmissions via the network 18 to the host system 12 regarding real-time or substantially real-time events (e.g., user updates, photographic or illustration image updates, and/or property information updates). Data transmission may be through any type of communication including, but not limited to, speech, visuals, signals, textual, and/or the like. Events may include, for example, data transmissions regarding user messages or updates from a real estate agent, for example, initiated via the external system 19. It should be noted that the external system 19 may be the same type and construction as the buyer device 14.

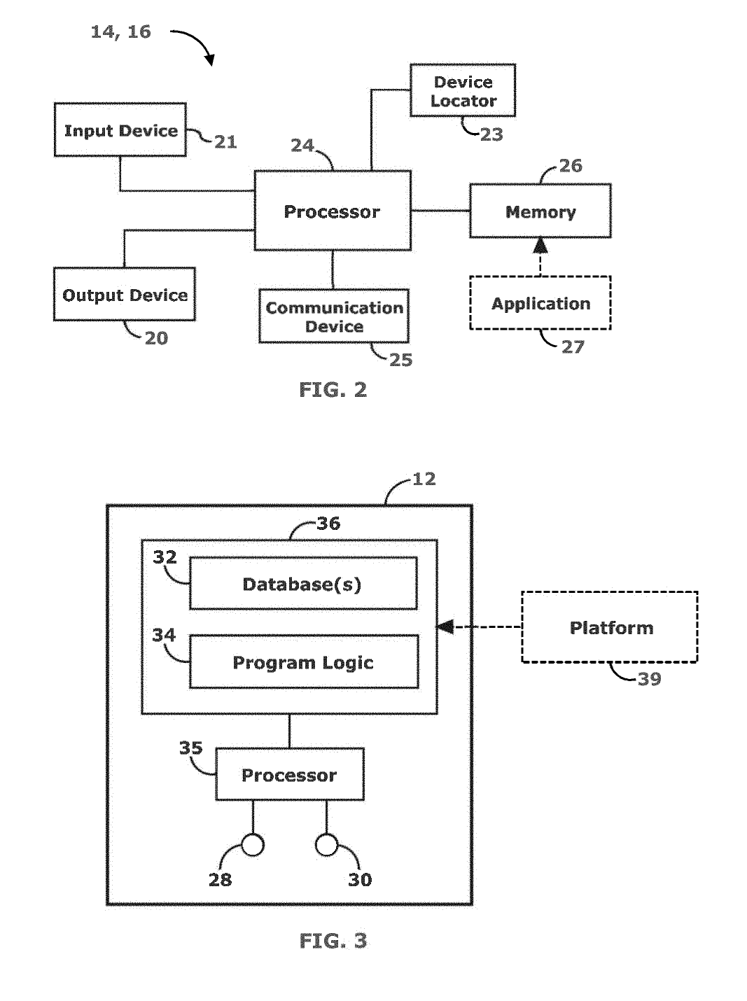

As described herein, the buyer device 14 and the realtor device 16 may be implemented as similar devices. Therefore, in the interest of brevity, the elements of the buyer device 14 and the realtor device 16 will be described herein using the same numerical designations. As shown in FIG. 2, the buyer device 14 and the realtor device 16 of the system 10 may include, but are not limited to implementation as a personal computer, a cellular telephone, a smart phone, a tablet, a laptop computer, a desktop computer, a network-capable handheld device, a server, a wearable network-capable device, and/or the like.

In some embodiments, the buyer device 14 and the realtor device 16 may include one or more output devices 20 (hereinafter “output device 20”), one or more input devices 21 (hereinafter “input device 21”), a device locator 23, one or more processors 24 (hereinafter “processor 24”), one or more communication devices 25 (hereinafter “communication device 25”) capable of interfacing with the network 18, one or more non-transitory memory 26 (hereinafter “memory 26”) storing processor executable code and/or software application(s), for example including, a web browser capable of accessing a website and/or communicating information and/or data over a wireless or wired network (e.g., network 18), and/or the like.

The memory 26 may also store an application 27 that, when executed by the processor 24 causes the buyer device 14 to automatically and without user intervention collect predefined property information based on the user's current location as determined by the device locator 23 to allow the user to quickly and accurately select a property they would like to see, select a realtor to show them the property, and track the selected realtor's progress as they travel to the showing.

Embodiments of the system 10 may also be modified to use any future developed devices capable of communicating with the host system 12 via the network 18 as the buyer device 14 and/or the realtor device 16.

The device locator 23 may be configured to determine the position of the buyer device 14 and/or the realtor device 16. For example, implementations of the device locator 23 may include, but are not limited to, a Global Positioning System (GPS) chip, software based device triangulation methods, network-based location methods such as cell tower triangulation or trilateration, the use of known-location wireless local area network (WLAN) access points using the practice known as “wardriving”, a hybrid positioning system combining two or more of the technologies listed above, or any future developed system or method of locating a device such as the buyer device 14 and/or the realtor device 16.

The input device 21 may be configured to receive information input from the user and/or processor 24, and transmitting such information to other components of the buyer device 14, the realtor device 16, and/or the network 18. The input device 21 may include, but are not limited to, implementation as a keyboard, touchscreen, mouse, trackball, microphone, fingerprint reader, infrared port, slide-out keyboard, flip-out keyboard, cell phone, PDA, remote control, fax machine, wearable communication device, network interface, combinations thereof, and/or the like, for example.

The output device 20 may be capable of outputting information in a form perceivable by the user and/or processor 24. For example, implementations of the output device 20 may include, but are not limited to, a computer monitor, a screen, a touchscreen, a speaker, a website, a television set, a smart phone, a PDA, a cell phone, a printer, a laptop computer, combinations thereof, and the like, for example. It is to be understood that in some exemplary embodiments, the input device 21 and the output device 20 may be implemented as a single device, such as, for example, a touchscreen of a computer, a tablet, or a smartphone. It is to be further understood that as used herein the term user is not limited to a human being, and may comprise, a computer, a server, a website, a processor, a network interface, a human, a user terminal, a virtual computer, combinations thereof, and/or the like, for example.

The host system 12 may be configured to interface and/or communicate with the buyer device 14, the realtor device 16, and the external system 19 via the network 18. For example, the host system 12 may be configured to interface by exchanging signals (e.g., analog, digital, optical, and/or the like) via one or more ports (e.g., physical ports or virtual ports) using a network protocol, for example. Additionally, each host system 12 may be configured to interface and/or communicate with other host systems 12 directly and/or via the network 18, such as by exchanging signals (e.g., analog, digital, optical, and/or the like) via one or more ports.

The network 18 may permit bi-directional communication of information and/or data between the host system 12, the buyer device 14, the realtor device 16, and/or the external system 19. The network 18 may interface with the host system 12, the buyer device 14, and/or the external system 19 in a variety of ways. For example, in some embodiments, the network 18 may interface by optical and/or electronic interfaces, and/or may use a plurality of network topographies and/or protocols including, but not limited to, Ethernet, TCP/IP, circuit switched path, combinations thereof, and/or the like. For example, in some embodiments, the network 18 may be implemented as the World Wide Web (or Internet), a local area network (LAN), a wide area network (WAN), a metropolitan network, a 4G network, a satellite network, a radio network, an optical network, a cable network, a public switch telephone network, an Ethernet network, combinations thereof, and the like, for example. Additionally, the network 18 may use a variety of network protocols to permit bi-directional interface and/or communication of data and/or information between the host system 12, the buyer device 14, the realtor device 16, and/or the external system 19.

Referring now to FIG. 3, shown therein is a diagrammatic view of an exemplary embodiment of the host system 12. In the illustrated embodiment, the host system 12 is provided with one or more databases 32 (hereinafter “database 32”), program logic 34, and one or more processors 35 (hereinafter “processor 35”). The program logic 34 and the database 32 are stored on non-transitory computer readable storage memory 36 (hereinafter “memory 36”) accessible by the processor 35 of the host system 12. It should be noted that as used herein, program logic 34 is another term for instructions which can be executed by the processor 24 or the processor 35. The database 32 can be a relational database or a non-relational database. Examples of such databases comprise, DB2®, Microsoft® Access, Microsoft® SQL Server, Oracle®, mySQL, PostgreSQL, MongoDB, Apache Cassandra, and the like. It should be understood that these examples have been provided for the purposes of illustration only and should not be construed as limiting the presently disclosed inventive concepts. The database 32 can be centralized or distributed across multiple systems.

In some embodiments, the host system 12 may comprise one or more processors 35 working together, or independently to, execute processor executable code stored on the memory 36. Additionally, each host system 12 may include at least one input device 28 (hereinafter “input device 28”) and at least one output device 30 (hereinafter “output device 30”). Each element of the host system 12 may be partially or completely network-based or cloud-based, and may or may not be located in a single physical location.

The processor 35 may be implemented as a single processor or multiple processors working together, or independently, to execute the program logic 34 as described herein. It is to be understood, that in certain embodiments using more than one processor 35, the processors 35 may be located remotely from one another, located in the same location, or comprising a unitary multi-core processor. The processors 35 may be capable of reading and/or executing processor executable code and/or capable of creating, manipulating, retrieving, altering, and/or storing data structures into the memory 36.

Exemplary embodiments of the processor 35 may be include, but are not limited to, a digital signal processor (DSP), a central processing unit (CPU), a field programmable gate array (FPGA), a microprocessor, a multi-core processor, combinations, thereof, and/or the like, for example. The processor 35 may be capable of communicating with the memory 36 via a path (e.g., data bus). The processor 35 may be capable of communicating with the input device 28 and/or the output device 30.

The processor 35 may be further configured to interface and/or communicate with the buyer device 14, the realtor device 16, and/or the external system 19 via the network 18. For example, the processor 35 may be configured to communicate via the network 18 by exchanging signals (e.g., analog, digital, optical, and/or the like) via one or more ports (e.g., physical or virtual ports) using a network protocol to provide updated information to the application 27 executed on the buyer device 14 such as, for instance, real-time location updates for a realtor travelling to show a property to the buyer as will be discussed in further detail herein.

The memory 36 may store processor executable code and may be implemented as a conventional non-transitory memory, such as for example, random access memory (RAM), CD-ROM, a hard drive, a solid state drive, a flash drive, a memory card, a DVD-ROM, a disk, an optical drive, combinations thereof, and/or the like.

In some embodiments, the memory 36 may be located in the same physical location as the host system 12, and/or one or more memory 36 may be located remotely from the host system 12. For example, the memory 36 may be located remotely from the host system 12 and communicate with the processor 35 via the network 18. Additionally, when more than one memory 36 is used, a first memory 36 may be located in the same physical location as the processor 35, and additional memory 36 may be located in a location physically remote from the processor 35. Additionally, the memory 36 may be implemented as a “cloud” non-transitory computer readable storage memory (i.e., one or more memory 36 may be partially or completely based on or accessed using the network 18).

The input device 28 of the host system 12 may transmit data to the processor 35 and may be similar to the input device 21 of the buyer device 14 and the realtor device 16. The input device 28 may be located in the same physical location as the processor 35, or located remotely and/or partially or completely network-based. The output device 30 of the host system 12 may transmit information from the processor 35 to the user, and may be similar to the output device 20 of the buyer device 14 and the realtor device 16. The output device 30 may be located with the processor 24, or located remotely and/or partially or completely network-based.

The memory 36 may store processor executable code and/or information comprising the database 32 and program logic 34. In some embodiments, the processor executable code may be stored as a data structure, such as the database 32 and/or data table, for example, or in non-data structure format such as in a non-compiled text file.

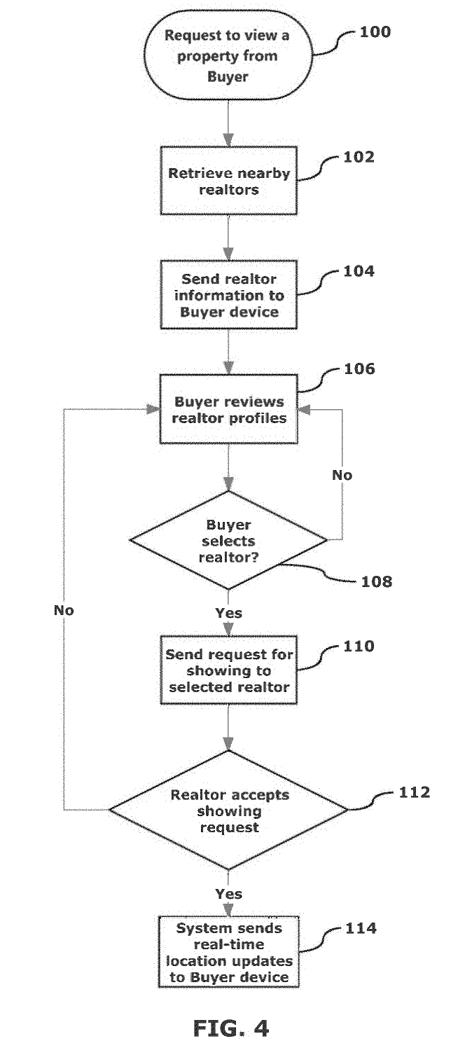

The system 10 may include the application 27 executed by the processor 24 of the buyer device 14 or the realtor device 16 that is capable of communicating with the host system 12 via the network 18. FIG. 4 is a flow diagram illustrating operation of the application 27 for a user who is a buyer. At a step 100 the application 27 directs the processor 24 to transmit a request for showing to the host system 12 via the communication device 25 and the network 18. The request for the showing from the buyer device 14 may be received at the host system 12. The request may include information that identifies the user requesting the showing (i.e., identification data), his or her location (i.e., location data such as latitude/longitude), and information about the property (i.e., property data).

The identification data may be user data that is associated with the user that is logged into the application 27 on the buyer device 14. The user data may be stored locally on the buyer device 14 or may be stored on the host system 12 in the database 32, for instance, and accessed over the network 18. The user data may include, for instance, the name of the user, a phone number, an email address, social security number, ein number or other personally identifiable information to allow a potential realtor to contract the user after the request for showing has been received.

The location data may be captured in real-time by the device locator 23 at the buyer device 14 upon the user requesting the with the input device 21. The application 27 may be programmed to access the location data being generated by the device locator 23 only when authorized. For instance, the application 27 may be authorized to access the location data 1) whenever the application 27 is open, 2) when the user selects an option with the input device 21 that requires the application 27 to access the location data, or 3) the application 27 may be programmed to require user authorization from the input device 21 every time location data is required. It should be noted that the application 27 may be programmed to allow access to the location data in other schemes so long as the user's location data is only transmitted upon authorization by the user.

The property data may be obtained in one embodiment of the application 27 by sending the location data generated by the device locator 23 to the host system 12 via the network 18. In this embodiment, the host system 12 is programmed to match the location data with a property listed for sale which may be stored, for instance in the database 32 on the host system 12, or in another database such as a database associated with a property listing service known as the Multiple Listing Service (MLS). The match can be made, for example, by . . . In some embodiments of the system 10, the list of properties currently listed for sale may include both standard real estate listings (i.e. the seller contracted with a real estate agent or real estate agency to list the property for sale), and FSBO real estate listings (i.e. where the seller listed the property for sale themselves but has agreed to pay a predetermined fee to a real estate agent or real estate agency who finds a buyer for the FSBO property). In another embodiment of the system 10, the list of properties currently listed for sale may include only FSBO real estate listings. Once the host system 12 has located a property matching the location data, the host system 12 may be programmed to send the property data to the buyer device 14 via the network 18 and the communication device 25. In such an embodiment, the application 27 may be programmed to show the property data to the user in such a way that the user may verify that the property data is for the property they want to see. For example, a picture of the property and/or an address of the property can be provided and displayed on the output device 20. In another embodiment, the host system 12 may be programmed to associate the property data with the user so that the property data may be automatically appended to the request for showing when the request for showing is sent.

In an instance where the host system 12 is unable to match property data with the location data, the application 27 may be programmed to allow the user to manually enter information about the property using the input device 21 such as a physical address, a picture or pictures taken using the buyer device 14, an MLS number, listing realtor/agency information, or other information which will allow a realtor to locate the property data.

At a step 102, the host system 12 may retrieve a set of nearby, available realtors, such as from the database 32 stored on the memory 36 of the host system 12. Nearby realtors may be those within a predefined distance or vicinity of the buyer device 14 as defined by the location data. It is noted that this distance may be variable. For instance, the predefined distance may have a default value, i.e. 5 miles, and may increase if no realtors are in the immediate vicinity of the user. Available realtors may be those who have logged into the application 27 with the input device 21, those that have indicated they are available, for instance, by selecting an appropriately programmed button in the application 27, or those that have not previously accepted a showing request within a predetermined time. In another embodiment, the application 27 may be programmed to determine the availability of a realtor after a showing by, for instance, determining when the current location of the realtor device 16 and the user device 14 are a predetermined distance apart.

To keep a location of the realtors current, the host system 12 may be programmed to ping the realtor device 16 of each realtor on a predetermined or random schedule to determine the current location of the realtor device 16 once the realtor has logged into the application 27 for the day, for instance. In other embodiments, the application 27 on the realtor devices 16 may be programmed to periodically or randomly report location data to the host system 12 to allow the location of the realtor device 16, i.e., the realtors' locations to be updated by the host system 12. In some embodiments, realtors may manually initiate reporting of location data from their realtor devices 16 to the host system 12, such as by logging or checking in with the host system 12. In another embodiment, the application 27 may be programmed to send the realtor device 16 location data at a variety of instants of time to the host system 12 during a selected time frame such as, for instance, 8:00 a.m. to 6:00 p.m. local time. The realtors' location data can then be used by the host system 12 to identify the realtors that are near the user.

In step 104, the host system 12 sends information regarding the realtor location data to the buyer device 14 via the network 18. The application 27 on the buyer device 14 may be programmed to display the realtor location data as selectable indicators on a map, displayed by the output device 20 for instance, of the area surrounding the user location. Such an embodiment can be seen in FIG. 8, which will be described in more detail herein.

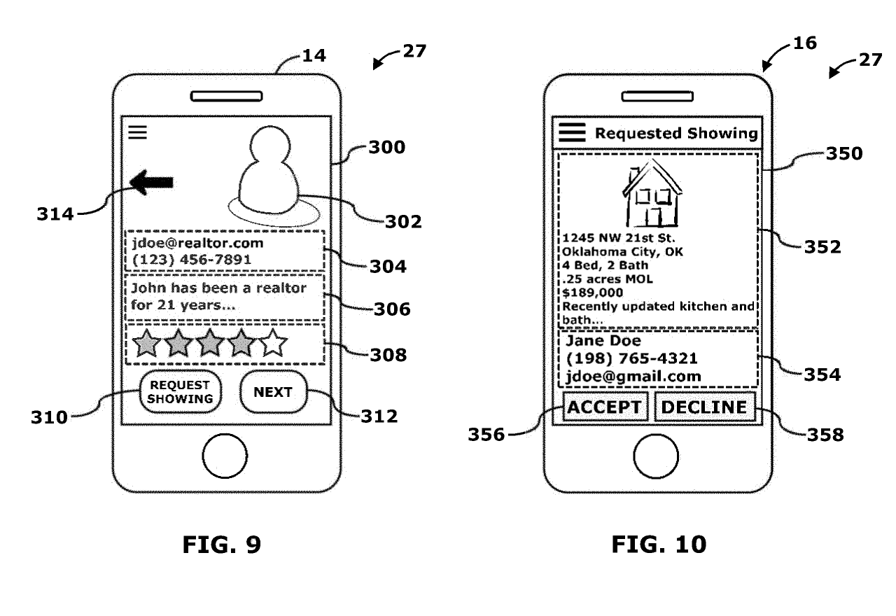

In step 106, the buyer may review a profile of realtors by clicking, touching, or otherwise selecting the selectable indicator associated with the desired realtor on the output device 20. In one embodiment of the application 27, the realtor profile may be displayed on a realtor information screen 300 by the output device 20 such as the one shown in FIG. 9, which will be described in more detail herein.

At a decision step 108, the application 27 may determine if the user has selected a realtor after reviewing their profile. If the user has not selected a realtor, the application 27 may return to step 106 to allow the user to review additional realtor profiles until the buyer finds a realtor the buyer would like to work with.

At decision step 108, if the buyer has selected a realtor that the buyer would like to work with, as shown at step 110 the application 27 may be programmed to send a request for a showing to the selected realtor via the communication device 25 and the network 18. For instance, the application 27 may send the user identification data, user location data, and property data via the network 18 to the host system 12, the host system 12 being programmed to send that data with the request for showing to the realtor device 16 via the network 18.

At decision step 112, it may be determined if the selected realtor has accepted or confirmed a proposed showing from the user. This ensures that the realtor is available to show the property. In operation, the realtor may enter a confirmation into the realtor device 16 via the input device 21. The application 27 may transmit a realtor confirmation message from the realtor device 16 to the host system 12 via the network 18. Confirmation may also or alternatively require the realtor to call, text, or otherwise communicate directly with the user in some embodiments. This communication allows further details to be exchanged between the buyer and realtor, such as a specific meeting location for the showing (which may or may not be at the property's location).

If confirmed, a confirmation message may be presented on the user device 14 at a step 114. In one embodiment of the application 27, when the realtor accepts the proposed showing, in addition to the confirmation message, the host system 12 is programmed to send real-time location updates of the realtor device 16 to the buyer device 14. In such an embodiment, the application 27 is programmed to cause the device locator 23 of the realtor device 16 to send real-time updates of the location of the realtor device 16 to the host system 12 via the processor 24, the communication device 25 and the network 18. The host system 12 is programmed to send the realtor device 16 location to the buyer device 14 via the network 18 and the communication device 25 to update the buyer as the realtor travels to the showing as will be described further herein. In some embodiments, the host system 12 may be programmed to send the realtor device 16 location data to the buyer device 14 at a variety of instants of time during a predetermined period of time, such as 30 minutes.

If declined or the realtor does not confirm within a predefined time limit, the buyer may be notified of the same by the host system 12. The user may then select another realtor at step 104. The process may then continue from step 106 as described above.

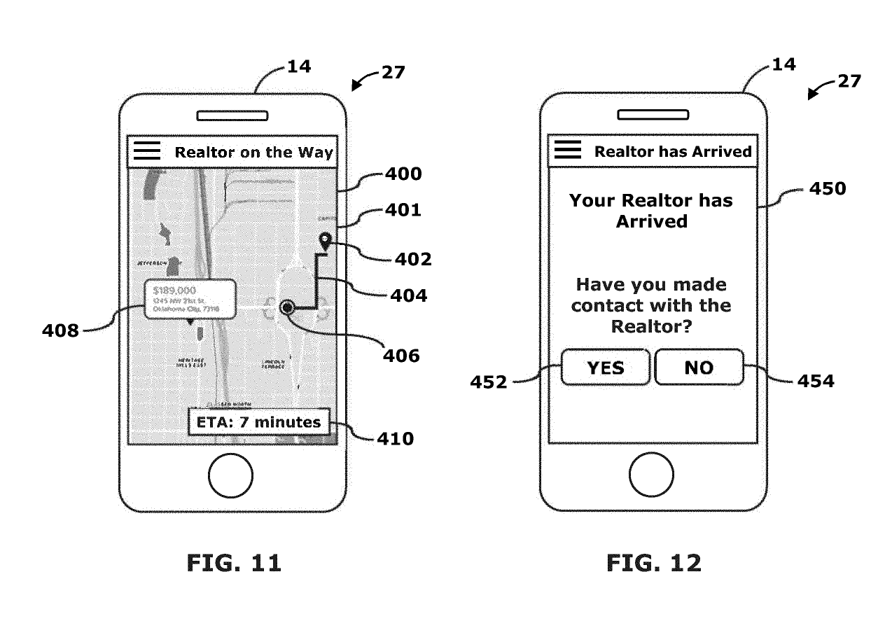

At step 114, the host system 12 begins to collect and send real-time location updates of the realtor device 16 to the buyer device 14. The location updates may be displayed on the buyer device 14 as a visible indicator on a map (401 FIG. 11) such as the embodiment shown in FIG. 11, which will be described in more detail herein. As shown in FIG. 11, the map 401 may also show a visible indicator (marker 408) of the location of the buyer device 14 on the map 401 as well so the buyer can determine the realtor's location relative to the buyer's location as the realtor travels to the showing. In some embodiments, the application 27 may be programmed to calculate and display an estimated time of arrival (ETA) so that the buyer is apprised, in real-time, of the time that the realtor will arrive at the showing. The ETA can be calculated by determining a velocity of the realtor device 16 and multiplying the velocity by a distance to the showing. The distance to the showing may be calculated by running a length of road segments between the location of the realtor device 16 and the location of the showing.

Once the realtor arrives at the showing, the host system 12 and application 27 may be programmed to handle location services of the buyer device 14 and the realtor device 16 in a number of ways. For instance, in one embodiment, the host system 12 may be programmed to automatically stop sending real-time location updates of the realtor device 16 to the buyer device 14 when the host system 12 determines that the realtor device 16 and the buyer device 14 are within a predetermined distance of one another for a predetermined period of time. In such an embodiment, the predetermined distance may be within a range of between 0 feet and 300 feet and the predetermined period of time may be within a range of between 5 minutes and 30 minutes. In one embodiment, the host system 12 may be programmed to stop sending real-time location updates of the realtor device 16 to the buyer device 14 once the host system 12 determines the realtor device 16 has reached the location of the showing. In another embodiment, the host system may be programmed to stop sending real-time location updates of the realtor device 16 to the buyer device 14 after a predetermined period of time. For instance, the predetermined period of time may be a time the host system 12 calculates it will take for the realtor to reach the location of the showing plus a cushion of time such as 5 minutes.

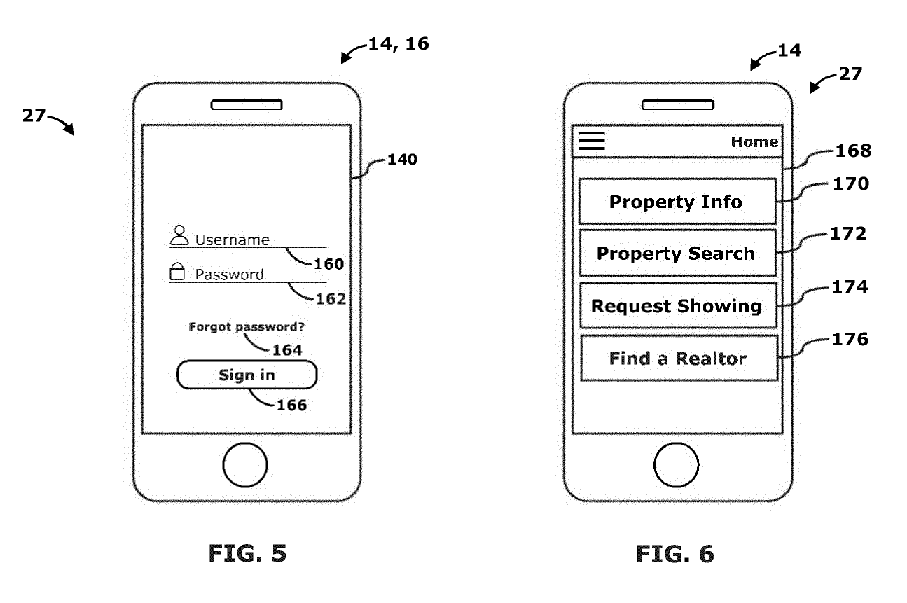

As illustrated in FIGS. 5-13, the system 10 for listing FSBO real estate for sale may include the application 27 executed by the processor 24 of the buyer device 14 that is capable of communicating with the host system 12 via the network 18. The system 10 may include a separate program, application or “app”, or a widget, each of which may correspond to instructions stored in the memory 26 of the buyer device 14 and/or the realtor device 16 for execution by the processor 24 of the buyer device 14 and/or the realtor device 16. Alternately, the system 10 may include instructions stored in the memory 36 of the host system 12 for execution by the processor 35 of the host system 12 with results sent via the network 18 to be displayed on the output device 20 of the buyer device 14 and the realtor device 16.

The instructions of the application 27, when executed by the processor 24 of the buyer device 14 and/or the realtor device 16, cause the buyer device 14 and/or the realtor device 16 to perform certain tasks. For example, such tasks may include displaying content such as a login screen 140 provided with fields designed for input from the user associated with the buyer device 14 and/or the realtor device 16 including, for instance, a username field 160, and a password field 162. In some embodiments of the application 27, the login screen 140 may also include a password retrieval function in the event a user loses or cannot remember their password to access the application 27. In the embodiment shown in FIG. 5, the password retrieval function may be initiated by selecting a forgot password button 164 on the login screen 140. Once the user has input their username in the username field 160 and their password in the password field 162, the user may select a sign in button 166 to access the application 27. An alternative login function (not shown) may also be present on the login screen 140, which provides login functionality and allows the user to login to the system 10 via other authentication or verification methods such as through the social networks Linkedin.com or Facebook.com. Some embodiments of the system 10 may also allow a new user to provide and register information from the login screen 140 of the application 27.

After the user logs in, the logic may branch from the login screen 140 to a buyer home screen 168 or a realtor home screen 500, for example, depending on the type of user logging in to the application 27. Shown in FIG. 6 is an exemplary buyer home screen 168 of the application 27. The buyer home screen 168 may be provided with a property info button 170, a property search button 172, a request showing button 174, and a find a realtor button 176. By selecting the property info button 170, or other suitably assigned or programmed button or interactivity option (such as swiping) available on the buyer device 14, the buyer may begin a location capture process to locate information about a property listed for sale, for instance. Each of these respective buttons allows the user to access the various aspects and screens of the application 27.

Selecting the property info button 170 causes the application 27 to obtain the buyer device's 14 current location using the device locator 23. The application 27 is programmed to send a signal indicating the current location of the buyer device 14 to the host system 12 via the network 18. Upon receipt of the signal indicating the current location of the buyer device 14, the host system 12 may be programmed to match the current location with a property listed for sale which may be stored, for instance in the database 32 on the host system 12, or in another database such as a database associated with a property listing service known as the Multiple Listing Service (MLS) using the MLS internet data exchange (IDX) feed. In some embodiments of the system 10, the list of properties currently listed for sale may include both standard real estate listings (i.e. the seller contracted with a real estate agent or real estate agency to list the property for sale), and FSBO real estate listings (i.e. where the seller listed the property without the assistance of a real estate agent but has agreed to pay a predetermined fee to a real estate agent or real estate agency who finds a buyer for the FSBO property). In another embodiment of the system 10, the list of properties currently listed for sale may include only FSBO real estate listings. Once the host system 12 has located a property within a predefined distance of the current location of the buyer device 14, the host system 12 is programmed to send the property listing information to the buyer device 14 via the network 18.

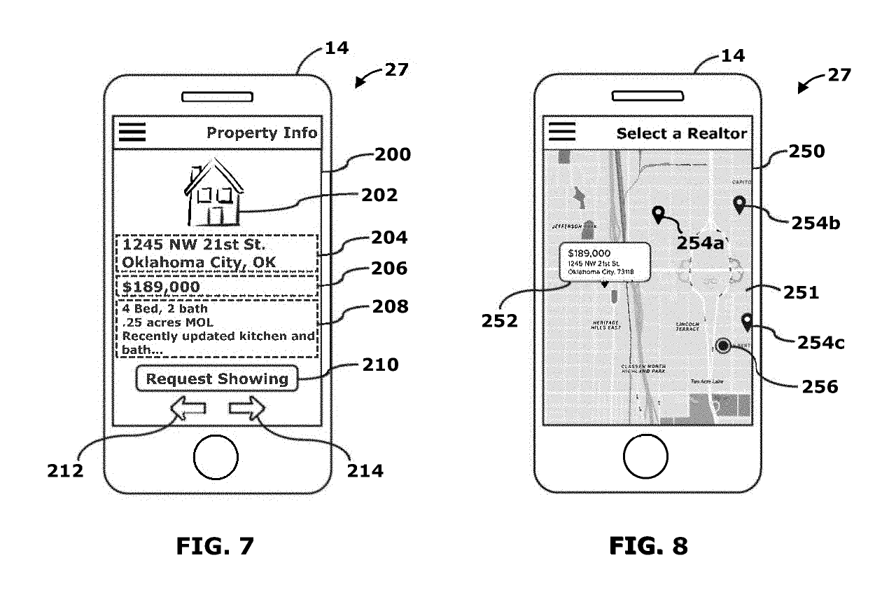

Upon receiving the property listing information, the application 27 on the buyer device 14 is programmed to display the property listing information on a property information screen 200, for instance as shown in FIG. 7. The property info motion screen 200 may be provided with at least one picture of the property 202, an address field 204, a price field 206, a property information field 208, a request showing button 210, a back button 212, and a next button 214. The property information screen 200 allows the buyer to verify that the property located is the property that the buyer would like to see as well as providing certain information about the property such as the address, a listing price, and square footage, number of bedrooms, number of bathrooms, size of the lot, etc. If the property is not the correct property, or if the buyer wishes to see information about a different property, the buyer may select appropriately programmed buttons such as the back button 212 or the next button 214. This will allow the buyer to navigate to different properties that the host system 12 has stored in the database 32, for instance. Selecting the next button 214, for instance, causes application 27 to send a signal to the host system 12 indicating that the buyer would like to see another property. In response to receiving the signal, the host system 12 may be programmed to send a next property associated with the current location of the buyer. On the other hand, if the buyer likes the property, the buyer can request a showing of the property by clicking or otherwise selecting the request showing button 210 of the property information screen 200.

When the buyer selects the request showing button 210, the application 27 may be programmed to send information to the host system 12 via the network 18. For instance, the application 27 may send the current location of the buyer device 14. Upon receipt of the request for showing and the current location of the buyer device 14, the host system 12 may be programmed to locate realtors who are currently active and able to show the property. In one embodiment, the host system 12 may be programmed to locate realtors who are currently active by pinging, or otherwise sending a connection signal to the realtor devices 16 that last reported being within a predetermined distance of the current location of the buyer device 14 to determine that the realtor devices 16 are still within the predetermined distance and still active and able to respond to the host system 12. If, for instance, a realtor device 16 is not able to respond to the ping sent by the host system 12, the host system 12 will not list that realtor device 16 as currently active. Likewise, if the realtor device 16 is determined to be outside the predetermined distance when pinged, the host system 12 will not list that realtor device 16.

It should be noted that the application 27 may be programmed to allow the buyer to pre-filter realtors. For instance, the buyer may be able to select preferences that indicate which realtors the buyer is willing to consider working with prior to searching for a realtor or a property using the application 27. Such preferences may include, but are not limited to, a minimum rating for the realtor, a number of years the realtor has been selling real estate, the agency for which the realtor works, a specific realtor, etc. In some embodiments, the buyer may be able to set the predetermined distance within which the host system 12 will search for available realtors.

Once the host system 12 has determined a list of realtor devices 16 that are within the predetermined distance from the current location of the buyer device 14 and are currently active and able to respond to the host system 12, the host system 12 is programmed to send the list of realtor devices 16 to the buyer device 14 where the application 27 is programmed to display the list of available realtors. The list of available realtors may be visually displayed on a realtor selection screen 250 overlaid as visual indicators on a map 251 as shown in FIG. 8.

As shown in FIG. 8, the application 27 may be programmed to display the current location of the buyer device 14 as a visual indicator such as marker 252, selectable visual indications of the available realtors as selectable markers 254a, 254b, and 254c, and a selectable visual indication of a real estate agency as selectable marker 256 overlaid on the map 251. In this way, the buyer may be able to visualize the location of available realtors in relation to the current location of the buyer device 14 in a manner well understood by most people, i.e., visualized on the map 251. This may facilitate selection of a realtor by the buyer to show the buyer the property.

The application 27 is programmed to provide the buyer with information about the available realtors to aid in the buyer's selection of a realtor. In one embodiment, the buyer may get additional information about the available realtors by clicking or otherwise selecting one of the markers 254a, 254b, and 254c associated with an available realtor. Selection of a marker 254a, 254b, or 254c causes the application 27 to display a realtor information screen 300, as shown in FIG. 9. It should be noted that the realtor information screen 300 may be a new screen in the application 27 or displayed as a pop-up screen as is known in the art. In either case, the realtor information screen 300 may be provided with a picture of the realtor 302, contact information in a contact information section 304, a description of the realtor's background or professional experience in a realtor information section 306, a rating of the realtor in a rating section 308, a select realtor button 310, a next button 312, and a back button 314.

After reviewing the realtor information on the realtor information screen 300, the buyer may indicate a desire to review information about the next realtor on the list of realtors by clicking or otherwise selecting the next button 312. Selection of the next button 312 causes the application 27 to display information about the next realtor on the list in the realtor information screen 300. The buyer may also select the back button 314 which will cause the application 27 to the buyer back to the realtor selection screen 250 where the buyer may visually select another realtor as described above.

Alternatively, the buyer may indicate a desire to work with the realtor by clicking or otherwise selecting the select realtor button 310. Selection of the select realtor button 310 causes the application 27 to send a signal to the host system 12 indicating the buyer's request to have the selected realtor show them the property. Once the host system 12 receives the request for a showing including the realtor the buyer has indicated would like to work with, the host system 12 is programmed to send a signal to the realtor device 16 associated with the selected realtor indicating the request for a showing.

Upon receiving the request for showing, the application 27 on the realtor device 16 associated with the selected realtor is programmed to display information associated with the requested showing on a requested showing screen 350, as shown in FIG. 10. The requested showing screen 350 may be provided with a property information section 352, a buyer information section 354, an accept showing button 356, a decline button 358, and a navigation button 360. The property information section 352 may include at least one picture of the property as well as identifying information about the property which may be stored in the database 32 on the host system 12, or may be acquired by the host system 12 from a third party source such as the MLS. The identifying information may include, but is not limited to, an address of the property, square footage, number of bedrooms, number of bathrooms, the size of the lot, a listing price, contact information to gain entry to the property, etc.

The buyer information section 354 may include information about the buyer/buyers including, but not limited to, name, address, contact information such as a phone number and email address, and whether or not the buyer has been pre-approved for financing, for instance. In some embodiments, the application 27 may include a mechanism such as a contact button (not shown) which would allow the realtor to contact the buyer directly by selecting the contact button.

The realtor may indicate acceptance of the showing request by clicking or otherwise selecting the accept button 356. The realtor may decline the showing request by clicking or otherwise selecting the decline button 358. When the realtor clicks the accept button 356, the application 27 is programmed to send a signal via the network 18 to the host system 12 indicating acceptance of the request for showing. In some embodiments of the application 27, the application 27 may be programmed to allow the realtor to enter a proposed time for a showing, for instance, if the property is not immediately available for a showing. In such an embodiment, the application 27 is programmed to send the proposed showing time as part of the signal indicating acceptance of the request for showing.

Upon receiving the signal indicating acceptance of the request for showing, the host system 12 is programmed to first determine if the signal includes a proposed time for a showing. If the signal does not include a proposed time for a showing, the host system 12 is programmed to send a signal via the network 18 to the buyer device 14 indicating that the request for showing has been accepted. The host system 12 may also be programmed to automatically indicate that the realtor who accepted the request for showing is no longer available, and thus, would not show on a list of available realtors when another buyer requests a showing. In such an embodiment, the host system 12 may be programmed to send a signal via the network 18 to the realtor device 16 indicating the status of not available. Information with respect to available/unavailable realtors can be stored in the database 32.

Upon receiving the signal indicating that the request for showing has been accepted, the application 27 on the buyer device 14 may be programmed to display a realtor progress tracking screen 400, as shown in FIG. 11. In the embodiment shown in FIG. 11, the realtor progress tracking screen 400 is provided with a map 401, a visual indicator of the realtor's starting position indicated by marker 402, a line 404 or other visual indicator showing the path the realtor has already travelled, a location marker 406 or other visual indicator of the current position of the realtor, a marker 408 or other visual indicator of the current location of the buyer device 14, and an ETA section 410 or other visual indication of the estimated time of arrival of the realtor at the showing.

After indicating acceptance of the requested showing, the application 27 on the realtor device 16 may be programmed to automatically cause the device locator 23 of the realtor device 16 to send a signal indicating real-time updates of the location of the realtor device 16 to the host system 12 via the network 18. Upon receipt of the signal, the host system 12 may be programmed to send a signal indicating the realtor device 16 location to the buyer device 14 to update the buyer as the realtor travels to the showing, the application 27 on the buyer device 14 being programmed to display the current location of the realtor as location marker 406 overlaid on the map 401 on the realtor progress tracking screen 400.

In one embodiment of the application 27, a realtor arrived screen 450 may be shown on the buyer device 14 when the host system 12 determines that the buyer device 14 and the realtor device 16 are within a predetermined distance of one another for a predetermined period of time. The realtor arrived screen 450 on the buyer device 14 may be provided with a yes button 452 and a no button 454 to allow the user to indicate whether or not they have made contact with the realtor. Clicking or otherwise selecting the yes button 452 causes the application 27 on the buyer device 14 to send a signal via the network 18 to the host system 12 indicating that the buyer and realtor have made contact. Upon receiving the signal, the host system 12 may be programmed to stop sending signals to the buyer device 14 indicating the current location of the realtor device 16.

It should be noted that the application 27 on the realtor device 16 may be programmed to display a screen (not shown) similar to the realtor arrived screen 450 allowing the realtor to indicate that the realtor and the buyer have made contact. In such an embodiment, the application 27 on the realtor device 16 may be programmed to send a signal via the network 18 to the host system 12 indicating that the buyer and realtor have made contact. Upon receiving the signal, the host system 12 may be programmed to stop sending signals to the buyer device 14 indicating the current location of the realtor device 16.

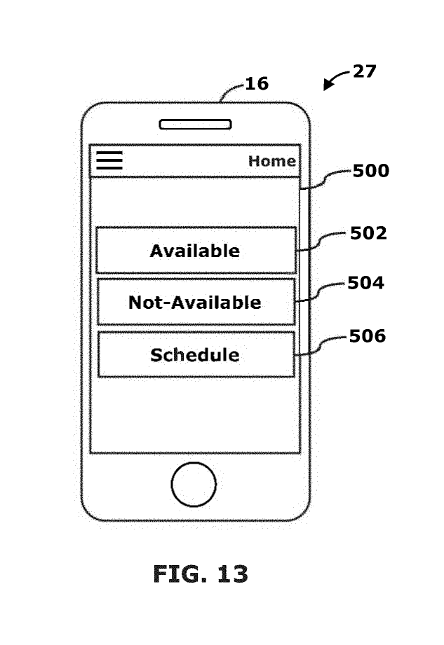

An exemplary realtor home screen 500 of the application 27 on the realtor device 16 is shown in FIG. 13. As shown in FIG. 13, the realtor home screen 500 may be provided with an available button 502, a not-available button 504, and a schedule button 506 that allow the realtor to indicate their availability currently and/or as scheduled for the day. For instance, when the realtor is available to show properties during the day, the realtor may click or otherwise select the available button 502. When the realtor selects the available button 502, the application 27 may be programmed to send a signal via the network 18 to the host system 12, the signal indicating that the realtor associated with that realtor device 16 is available to show properties. Upon receipt of the signal, the host system 12 may be programmed to mark or otherwise indicate in the database 32 that the realtor logged into the application 27 on the realtor device 16 is available to show properties after which, the host system 12 may be programmed to ping or otherwise contact the realtor device 16 constantly or at predetermined intervals to update the location of the realtor device 16. Upon receipt of the current location of the realtor device 16, the host system 12 may be programmed to update the database 32 to indicate the current location of the realtor logged into the realtor device 16. In this way, the host system 12 may keep track of which realtors are currently available and their current location.

The host system 12 may be programmed to continually update the location of the realtor device 16 until a triggering event happens. For instance, a triggering event may include, but is not limited to, the realtor clicking or otherwise selecting the not-available button 504, the realtor accepting a request for showing as described above, or the realtor may have had a scheduled event that the realtor entered into the application 27 using the schedule button 506. Other triggering events may include, for instance, a scheduled end of day event which may be entered using the schedule button 506 or entered globally (i.e., a beginning and end of day for every day of the week individually or the same beginning and end for the whole week) via preferences in the application 27. Whatever the triggering event, the application 27 will stop sending the current location of the realtor device 16 and the host system 12 may be programmed to automatically make the status of the realtor unavailable. In this way, buyers will only have access to the location of the realtor when the realtor is working or has otherwise indicated that they are available.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A method, comprising:
establishing communication between at least one host system having a processor, at least one buyer device having an input device, an output device, a communication device, and a device locator, and at least one realtor device having an input device, an output device, a communication device, and a device locator;
determining a current location of the at least one buyer device using the device locator;
receiving, by the buyer device, at least one selectable indicator associated with a location of available realtor located within a determined distance of the current location of the buyer device, the at least one selectable indicator displayed on the output device of the buyer device;
receiving, by the buyer device, input indicative of a selection of one of the at least one selectable indicator associated with the location of a realtor for showing a particular home to a buyer associated with the buyer device, the particular home associated with the current location of the buyer device;
sending, to the communication device of the realtor device, a request for showing the particular home;
receiving, from the realtor device, an acceptance of the request for showing the particular home; and
sending real-time updates to the buyer device by the at least one host system, the real-time updates indicative of locations of the selected realtor at instants of time as the selected realtor travels to a property showing of the particular home.

2. The method of claim 1, wherein the host system determines an estimated time of arrival of the realtor at the particular home and sends the estimated time of arrival to the buyer device.

3. The method of claim 1, wherein realtors indicate availability by selecting an appropriately programmed mechanism in an application on the realtor device.

4. The method of claim 3, wherein the host system is programmed to communicate with the realtor device on a predetermined schedule to determine the current location of the realtor device once the realtor has indicated availability in the application on the realtor device.

5. The method of claim 4, wherein the host system is programmed to communicate with the realtor device on the predetermined schedule to determine the current location of the realtor device until a triggering event happens.

6. The method of claim 5, wherein the triggering event comprises the realtor selecting a not-available button in the application on the realtor device, the realtor accepting a request for showing, a scheduled event that the realtor entered into the application using a schedule button, or a scheduled end of day event.

7. The method of claim 1, wherein the buyer may review a profile associated with a particular realtor by selecting the selectable indicator associated with the location of a realtor before requesting a showing of the particular home.

8. A system, comprising:
at least one buyer device having an input device, an output device, a communication device, a device locator, and non-transitory computer readable media storing an application;
at least one realtor device having an input device, an output device, a communication device, and a device locator, and non-transitory computer readable media storing an application;
at least one host system having a processor, a communication device, and non-transitory computer memory storing program data;
the application of the buyer device programmed to determine a current location of the at least one buyer device using the device locator and send the current location of the buyer device to the host system using the communication device;
upon receiving the current location of the buyer device, the program data of the host system causing the host system to determine available realtors a determined distance from the current location and send the available realtors to the buyer device;
upon receiving the available realtors, the application of the buyer device is programmed to causer the buyer device to display at least one selectable indicator associated with a location of available realtors, the at least one selectable indicator displayed on the output device of the buyer device;
the application on the buyer device programmed to receive input indicative of a selection of one of the at least one selectable indicator associated with the location of a realtor for showing a particular home to a buyer associated with the buyer device, the particular home associated with the current location of the buyer device, the application on the buyer device further programmed to send a signal indicative of the selected one of the at least one selectable indicators to the host system;
upon receiving signal indicative of the selected one of the at least one selectable indicators, the program data of the host system is programmed to send a request for showing the particular home to the communication device of the realtor device;
the application on the realtor device programmed to receive the request for showing the particular home and accept input indicative an acceptance of the request for showing the particular home; and
upon receiving an acceptance of the request for showing the particular home, the program data of the host system causes the host system to send real-time updates to the buyer device indicative of locations of the selected realtor device at instants of time as the selected realtor device travels to a property showing of the particular home.

9. The system of claim 8, wherein the host system determines an estimated time of arrival of the realtor device at the particular home and sends the estimated time of arrival to the buyer device.

10. The system of claim 8, wherein realtors indicate availability by selecting an appropriately programmed mechanism in the application on the realtor device.

11. The system of claim 10, wherein the host system is programmed to communicate with the realtor device on a predetermined schedule to determine the current location of the realtor device once the realtor has indicated availability in the application on the realtor device.

12. The system of claim 11, wherein the host system is programmed to communicate with the realtor device on the predetermined schedule to determine the current location of the realtor device until a triggering event happens.

13. The system of claim 12, wherein the triggering event comprises the realtor selecting a not-available button in the application on the realtor device, the realtor accepting a request for showing, a scheduled event that the realtor entered into the application using a schedule button, or a scheduled end of day event.

14. The system of claim 8, wherein a buyer may review a profile associated with a particular realtor by selecting the selectable indicator associated with the location of a realtor device before requesting a showing of the particular home.
